(19) United States
(12) Patent Application Publication
(10) Pub. No.: US 2013/0187816 A1
(43) Pub. Date: Jul. 25, 2013

(54) BAND-NOTCHED ULTRA-WIDEBAND ANTENNA

(71) Applicants: Shyh-Jong Chung, Guanxi Township (TW); Chao-Tang Chuang, Fenglin Township (TW)

(72) Inventors: Shyh-Jong Chung, Guanxi Township (TW); Chao-Tang Chuang, Fenglin Township (TW)

(73) Assignee: National Chiao Tung University, Hsinchu City (TW)

(21) Appl. No.: 13/539,836

(22) Filed: Jul. 2, 2012

(30) Foreign Application Priority Data
Jan. 20, 2012 (TW) 101102349

(51) Int. Cl. H01Q 1/36

(52) U.S. Cl. 343/722

(57) ABSTRACT

A band-notched ultra-wideband antenna comprises a top layer non-uniform short-circuit metal patch, a middle layer metal radiation patch, and a bottom layer metal patch. The bottom layer metal patch includes a coupled open/short circuit stub which is set close to the middle layer metal radiation patch. The equivalent circuit of the top layer non-uniform short-circuit metal patch is a parallel LC resonator, and the equivalent circuit of the coupled open/short circuit stub is a series LC resonator. The resonant frequency of the top layer non-uniform short-circuit metal patch is equivalent to the resonant frequency of the coupled open/short circuit stub, so as to function as a second-order bandstop filter to yield high notch-band-edge selectivity without increasing total circuit area of the band-notched ultra-wideband antenna.

### FIELD OF THE INVENTION

The present invention relates to an ultra-wideband antenna, especially to a band-notched ultra-wideband antenna.

### BACKGROUND OF THE INVENTION

Ultra-wideband was applied in military field at early stage. In 2002, FCC (Federal Communication Commission) in US authorized the licensed use of ultra-wideband (UWB) application in short-range and the bandwidth was set in the range of 3.1 to 10.6 GHz. Along with the evolution of the science and technology, mobile communication era has arrived, so the USW technology has been combining gradually with the mobile communication products.

Nowadays, wireless communication system products are increasingly evoluting in light and slim direction. In order to improve the circuit characteristics of the system, lower the circuit power loss and shorten the circuit size, circuit integration technology has become one of the most important research topic in mobile communication field. If the UWB antenna and the bandstop filter are integrated in a single circuit, not only wide band, high-frequency-edge selectivity, low loss, and miniaturization properties can be provided but also effective use of space and downsizing of circuit can be achieved.

The integration of UWB antenna and bandstop filter in a single circuit has been found in conventional technique. For example, U.S. Pat. No. 7,061,442B2 has disclosed an UWB antenna, as shown in FIG. 1, in which an U-shape slot 11 having half-wavelength of resonant frequency is provided in an UWB antenna 1 so as to provide bandstop function in the UWB antenna 1. However, the above design allows only one radiation null to be generated, and hence good notch-band-edge selectivity is impossible. Therefore, there are still rooms for improvement in current communication products.

Further, technology concerning the integration of UWB antenna and bandstop filter has also been disclosed in professional literatures. As shown in FIG. 2, in a first document (S.-W. Qu, J.-L. Li, and Q. Xue, “A band-notched ultra-wideband printed monopole antenna,” Antenna Wireless Propag. Lett., vol. 5, pp. 495-498, 2006), a first-order bandstop filter 21 and an UWB antenna 2 are integrated in circuit board 20 by a matching circuit 22. However, this conventional integration method needs additional circuit for synthesis, this might enlarge the overall circuit area and lower its applicability.

Next as shown in FIG. 3, in a second document (C.-Y. Hong, C.-W. Ling, I-Y. Tarn, and S.-J. Chung, “Design of a planar ultra-wideband antenna with a new band-notch structure,” IEEE Trans. Antenna propag., vol. 55, pp. 3391-3397, December 2007), a band-notch parallel LC resonant circuit 31 is designed to be within an UWB antenna 3 so as to achieve the purpose of miniaturization. This circuit needs not to use additional circuit area and the circuit having bandstop function is embedded in the UWB antenna, however there is only one radiation null in the stopband and hence good notch-band-edge selectivity is impossible.

In turn, as shown in FIG. 4, the third document (S.-J. Wu, C.-H. Kang, K.-H. Chen, and J.-H. Tarng, “Study of an ultra-wideband monopole antenna with a band-notched open-looped resonator,” IEEE Trans. Antenna Propag., vol. 58, pp. 1890-1897, June 2010), a band-notch parallel LC resonant circuit 41 is also designed to be embedded in an UWB antenna 4. Similarly, this circuit also needs not to use additional circuit area and the circuit having bandstop function is embedded in the UWB antenna. However there is only one radiation null generated in the stopband and hence good notch-band-edge selectivity is impossible.

Accordingly, how to integrate the UWB antenna and the bandstop filter effectively and to provide good notch-band-edge selectivity are worth exploring.

### SUMMARY OF THE INVENTION

In view of the abovementioned situation, this invention provides a band-notched ultra-wideband antenna, with a purpose to integrate the UWB antenna and the bandstop filter and to provide good notch-band-edge selectivity.

The band-notched ultra-wideband antenna of the present invention comprises a top layer non-uniform short-circuit metal patch connected with a signal transmission section; a middle layer metal radiation patch electrically connected to the top layer non-uniform short-circuit metal patch; and a bottom layer metal patch including a ground metal pad and a coupled open/short circuit stub which contains an open circuit stub and a short circuit stub, the short circuit stub being electrically connected to the middle layer metal radiation patch; wherein the equivalent circuit of the top layer non-uniform short-circuit metal patch is a parallel LC resonator, and the equivalent circuit of the coupled open/short circuit stub is a series LC resonator, the resonant frequency of the top layer non-uniform short-circuit metal patch being equivalent to the resonant frequency of the coupled open/short circuit stub, so that the top layer non-uniform short-circuit metal patch and the coupled open/short circuit stub combine to form a second-order bandstop filter. The combination of the second-order bandstop filter and the UWB antenna can generate two radiation nulls at the notch band and two transmission zeros at the notch band edge. Therefore, better notch-band-edge selectivity can be achieved.

The resonant frequency of the top layer non-uniform short-circuit metal patch and the coupled open/short circuit stub can be set at 5.5 GHz. Thus, the second-order bandstop filter can stop the transmission signal of frequency 5˜6 GHz so as to avoid the mutual interference with the other wireless signal (such as WLAN, 802.11a, the bandwidth used is between 5.015 GHz and 5.825 GHz.).

The middle layer metal radiation patch acts as the ground plane of the coupled open/short circuit stub and this is the main characteristics of the present invention. Further, the top layer non-uniform short-circuit metal patch is preferably a trapezoidal metal patch, the middle layer metal radiation patch is a pentagonal metal radiation patch, and the signal transmission section can be a microstrip feed line.

The open circuit stub and the short circuit stub of the present invention can be microstrip lines of equal or unequal length. Preferably, the length of the open circuit stub is a quarter-wavelength corresponding to the resonant frequency of the coupled open/short circuit stub. Furthermore, the length of the top layer non-uniform short-circuit metal patch is a quarter-wavelength corresponding to the resonant frequency of the top layer non-uniform short-circuit metal patch. The coupled open/short circuit stub is designed to be on the same plane in microstrip line mode, and the energy of two stubs is coupled with each other through a notch. Alternatively, the coupled open/short circuit stub can be realized by another method instead of microstrip line, such as coplanar waveguide (CPW), strip line or the like.

The band-notched ultra-wideband antenna provided by the present invention can reduce circuit area effectively, not only wide band and high-frequency-edge selectivity can be provided but also the purpose of circuit miniaturization can be achieved.

### BRIEF DESCRIPTION OF THE DRAWINGS

FIG. 1 is a schematic view of the conventional first ultra-wideband antenna.

FIG. 2 is a schematic view of the conventional second ultra-wideband antenna.

FIG. 3 is a schematic view of the conventional third ultra-wideband antenna.

FIG. 4 is a schematic view of the conventional fourth ultra-wideband antenna.

FIG. 5 (a) is an assembly view of the ultra-wideband antenna of a preferred embodiment of the present invention.

FIG. 5 (b) is an exploded view of the ultra-wideband antenna of a preferred embodiment of the present invention.

FIG. 6 is an equivalent circuit diagram of the top layer non-uniform short circuit metal patch, the coupled open/short circuit stub, and the middle layer metal radiation patch of the present invention.

FIG. 7 (a) is a schematic view of an open/short circuit stub resonator of prior art.

FIG. 7 (b) is a first schematic view of an open/short circuit stub resonator of the present invention.

FIG. 7 (c) is a second schematic view of an open/short circuit stub resonator of the present invention.

FIG. 8 (a) is a diagram showing the comparison of equivalent inductance extraction between the conventional open/short circuit stub resonator and the coupled open/short circuit stub of present invention in different line width.

FIG. 8 (b) is a diagram showing the comparison of computer simulation result of the coupled open/short circuit stubs in different line width.

FIG. 9 (a) is a comparison chart of return loss frequency response between the band-notched ultra-wideband antenna of the present invention and the conventional ultra-wideband antenna.

FIG. 9 (b) is a comparison chart of isotropic radiant power frequency response between the band-notched ultra-wideband antenna of the present invention and the conventional ultra-wideband antenna.

FIG. 10 (a) is the measurement result of antenna radiation pattern at low band of the ultra-wideband antenna of the band-notched ultra-wideband antenna of the present invention.

FIG. 10 (b) is the measurement result of antenna radiation pattern at stopband of the ultra-wideband antenna of the band-notched ultra-wideband antenna of the present invention.

FIG. 10 (c) is the measurement result of antenna radiation pattern at high band of the ultra-wideband antenna of the band-notched ultra-wideband antenna of the present invention.

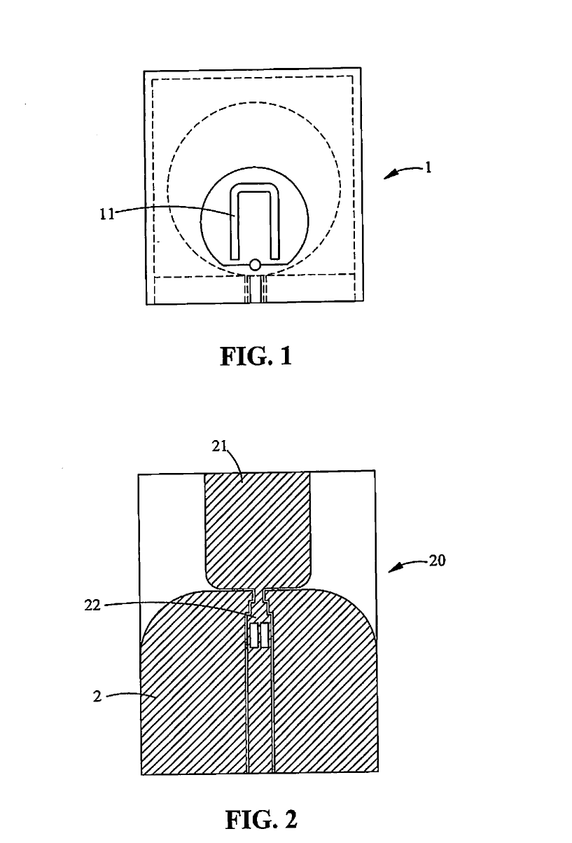

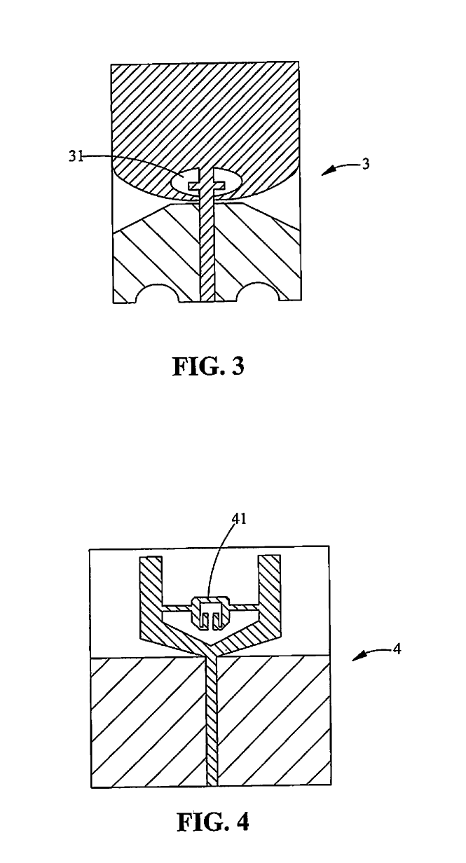

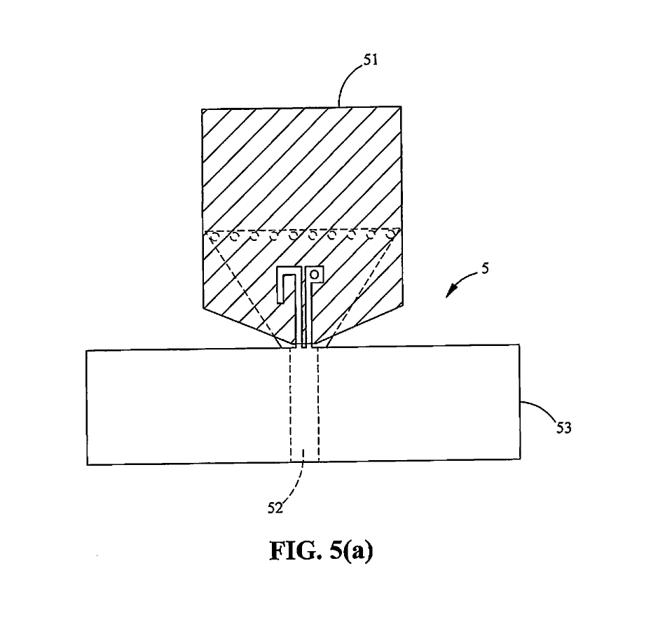

### DETAIL DESCRIPTION OF THE INVENTION

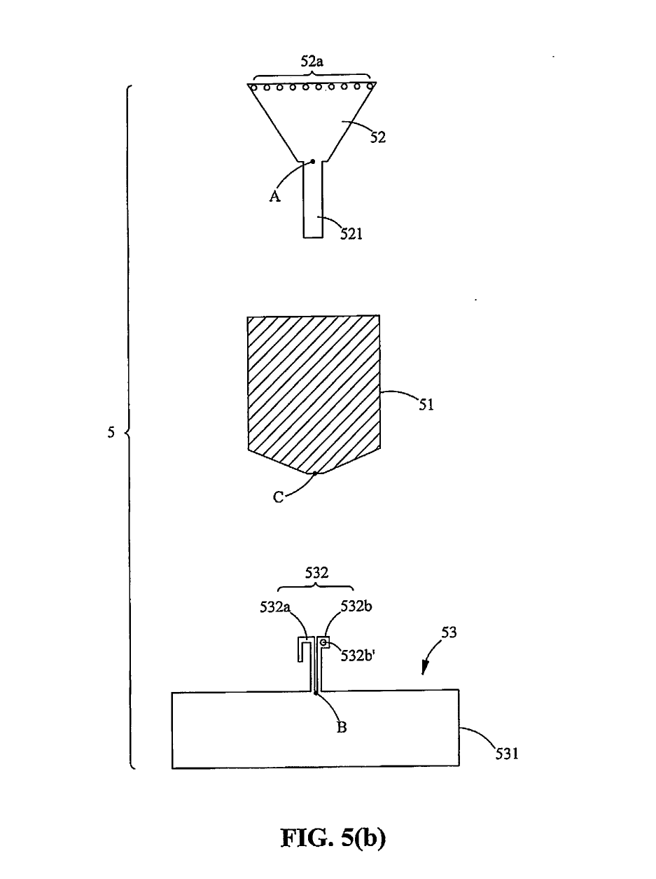

FIG. 5(a) is an assembly view of a preferred embodiment of the present invention, while FIG. 5(b) is an exploded view of a preferred embodiment of the present invention. As shown in these figures, the band-notched ultra-wideband antenna 5 of the present invention comprises a middle layer metal radiation patch 51, a top layer non-uniform short-circuit metal patch 52, and a bottom layer metal patch 53. The band-notched ultra-wideband antenna 5 of the present invention is a three-layer metal layer structure.

The top layer non-uniform short-circuit metal patch 52 is connected to a signal transmission section 521, and the top layer non-uniform short-circuit metal patch 52 is electrically connected to the middle layer metal radiation patch 51 through a plurality of connecting channels 52a. The bottom layer metal patch 53 includes a ground metal pad 531 and a coupled open/short circuit stub 532. The coupled open/short circuit stub 532 includes an open circuit stub 532a, a short circuit stub 532b, and the short circuit stub 532b is electrically connected to the middle layer metal radiation patch 51 through a connecting channel 532b′. In this embodiment, the middle layer metal radiation patch 51 is a pentagonal metal radiation patch, the top layer non-uniform short-circuit metal patch 52 is a trapezoidal metal patch, and the signal transmission section 521 is a microstrip feed line which is used to transmit the transmission signals about to be outgoing. In the present invention, the middle layer metal radiation patch 51 acts as a radiator of the ultra-wideband antenna 5 for sending out the transmission signals. In the mean time, the middle layer metal radiation patch 51 is also a ground plane of the coupled open/short circuit stub 532. This is the main characteristics of the present invention.

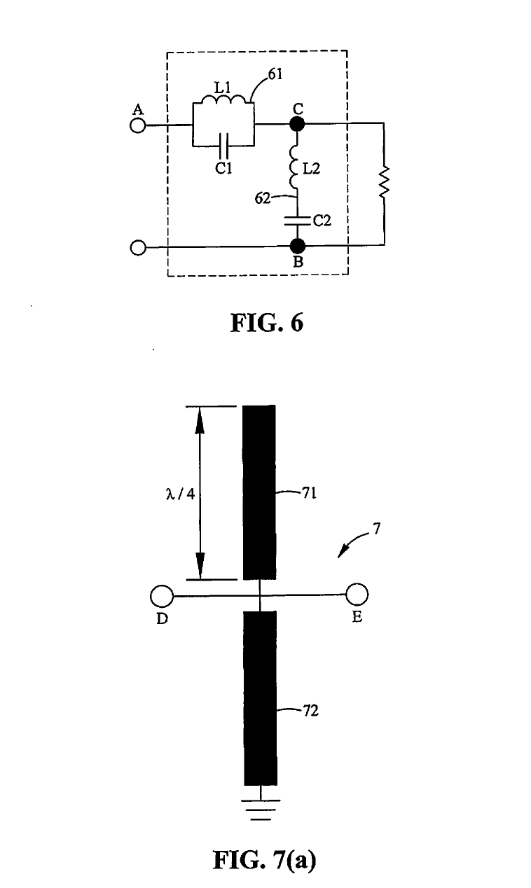

FIG. 6 is an equivalent circuit diagram of the top layer non-uniform short-circuit metal patch 52, the coupled open/short circuit stub 532, and the middle layer metal radiation patch 51 of the present invention. Referring to FIGS. 5 (b) and 6, the point A in FIG. 6 is equivalent to the point A in FIG. 5 (b), the point B in FIG. 6 to the point B in FIG. 5 (b), and the point C in FIG. 6 to the point C in FIG. 5 (b).

Again referring to FIGS. 5 (b) and 6, the length of the top layer non-uniform short-circuit metal patch 52 is a quarter-wavelength corresponding to the resonant frequency of the top layer non-uniform short-circuit metal patch 52, and the equivalent circuit thereof is a parallel LC resonator 61. The equivalent circuit of the coupled open/short circuit stub 532 is a series LC resonator 62. The resonant frequency of the top layer non-uniform short-circuit metal patch 52 (i.e., the parallel LC resonator 61) is

$$\frac{1}{2 π \sqrt{{L}_{1} {C}_{1}}} ,$$

and the resonant frequency of the coupled open/short circuit stub 532 (i.e., the series LC resonator 62) is

$$\frac{1}{2 π \sqrt{{L}_{2} {C}_{2}}} .$$

In this embodiment, the resonant frequency of the top layer non-uniform short-circuit metal patch 52 is equivalent to the resonant frequency of the coupled open/short circuit stub 532 so that the top layer non-uniform short-circuit metal patch 52 and the coupled open/short circuit stub 532 combine together to form a second-order bandstop filter.

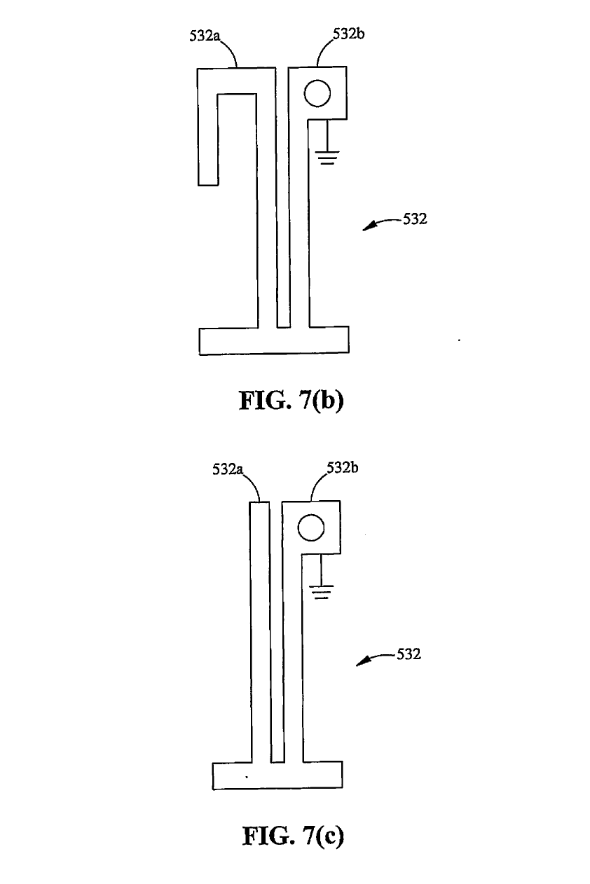

The design of the coupled open/short circuit stub 532 is also a main characteristics of the present invention. This characteristics will be described clearly in reference to FIGS. 7 (a) and 7 (b). FIG. 7 (a) is a structure of conventional open/short circuit stub resonator 7, while FIG. 7 (b) is a structure of the coupled open/short circuit stub 532 of the present invention. As shown in FIG. 7 (a), the conventional open/short circuit stub resonator 7 is mainly a series structure formed by an open circuit stub 71 having its length equal to a quarter-wavelength of the resonant frequency together with a short circuit stub 72, with point D as the signal input end and point E as the signal output end. When the frequency of the transmission signal is lower than the resonant frequency, the open circuit stub 71 and the short circuit stub 72 respectively display capacitance property and inductance property so as to form a parallel LC resonator; when the frequency of the transmission signal is higher than the resonant frequency, the open circuit stub 71 and the short circuit stub 72 respectively display inductance property and capacitance property so as to form a parallel LC resonator. However, in this structure, the open circuit stub 71 operating at resonant frequency can only provide a lower equivalent inductance value so that the conventional structure is not suitable for designing bandstop filter of narrow bandwidth.

As compared with the conventional structure, the coupled open/short circuit stub 532 of the present invention is of a coupling type, i.e. the open circuit stub 532a and the short circuit stub 532b are disposed parallelly along the same direction. This design can allow the series LC resonator operating at resonant frequency to generate a higher equivalent inductance value. In order to increase the degree of freedom in design, this invention provides two design modes for coupled open/short circuit stub. The open circuit stub 532a and the short circuit stub 532b can be microstrip lines of equal or unequal length. In this embodiment, the open circuit stub 532a and the short circuit stub 532b are unequal in length and the length of the open circuit stub 532a is a quarter-wavelength corresponding to the resonant frequency of the coupled open/short circuit stub 532. Moreover, the open circuit stub 532a and the short circuit stub 532b can be designed to be equal in length, and the length of the open circuit stub 532a or the short circuit stub 532b is a quarter-wavelength corresponding to the resonant frequency of the coupled open/short circuit stub 532, as shown schematically in FIG. 7 (c). Alternatively, the coupled open/short circuit stub 532 can be realized by another method instead of microstrip line, such as coplanar waveguide (CPW), strip line or the like.

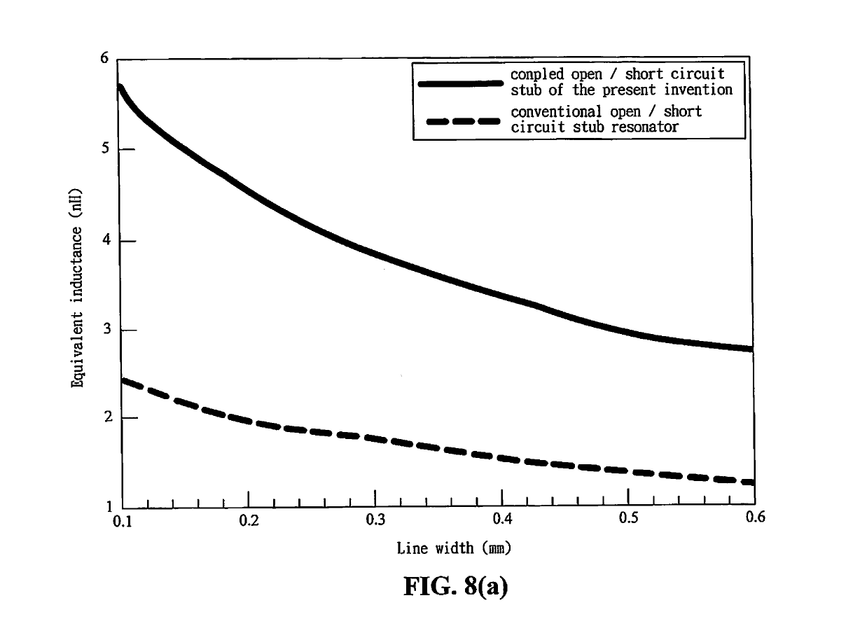

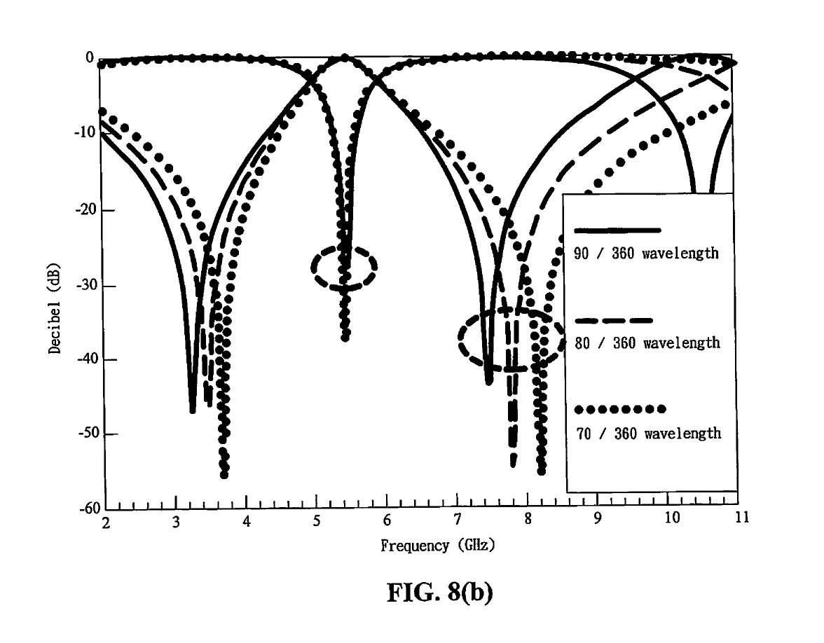

Similar to the conventional open/short circuit stub resonator 7, the coupled open/short circuit stub 532 provided in the present invention is operated as the series LC resonator at the central band, while a pair of transmission zeros are produced at both sides of the notch-band. FIG. 8 (a) is a diagram showing the comparison of equivalent inductance extraction between the conventional open/short circuit stub resonator 7 and the coupled open/short circuit stub 532 of present invention in different line width. It is understood that, as compared to the conventional open/short circuit stub resonator 7, the coupled open/short circuit stub 532 of present invention can provide a higher equivalent inductance value.

Next, as to the open circuit stub 532a and the short circuit stub 532b being microstrips of equal or unequal length, the present invention also provides computer simulation result to describe its effect. Referring to FIG. 8 (b), when the central frequency is 5.5 GHz, the length of the open circuit stub 532a is fixed at a quarter-wavelength (90/360), while the length of the short circuit stub 532b can be adjusted to 90/360 wavelength, 80/360 wavelength, and 70/360 wavelength alternatively. It is apparent from the drawings that the frequency response near the central frequency will not change due to the different length of the short circuit stub 532b, which means that the length of the short circuit stub 532b does not affect the central frequency. When the lengths of the open circuit stub 532a and the short circuit stub 532b are all a quarter-wavelength (90/360), it is understood that transmission zeros are generated respectively at 3.3 GHz and 7.5 GHz. When the short circuit stub 532b is gradually shortened, it is observed that two transmission zeros are shifted to high frequency, in which the transmission zero of higher frequency moves faster than that of lower frequency. When designing a bandstop filter, the bandwidth and frequency response outside the notch-band (i.e., the passband frequency band) can be improved by suitably controlling the frequency of the transmission zero. Therefore, the coupled open/short circuit stub 532 of present invention not only provides higher inductance value at the central frequency but also provides additional degree of freedom in design so as to control efficiently the property of the passband frequency band. In actual design, the coupled open/short circuit stub 532 having equal length can be designed first, and then the length of the coupled open/short circuit stub 532 can be adjusted according to the required ultra-wideband antenna bandwidth.

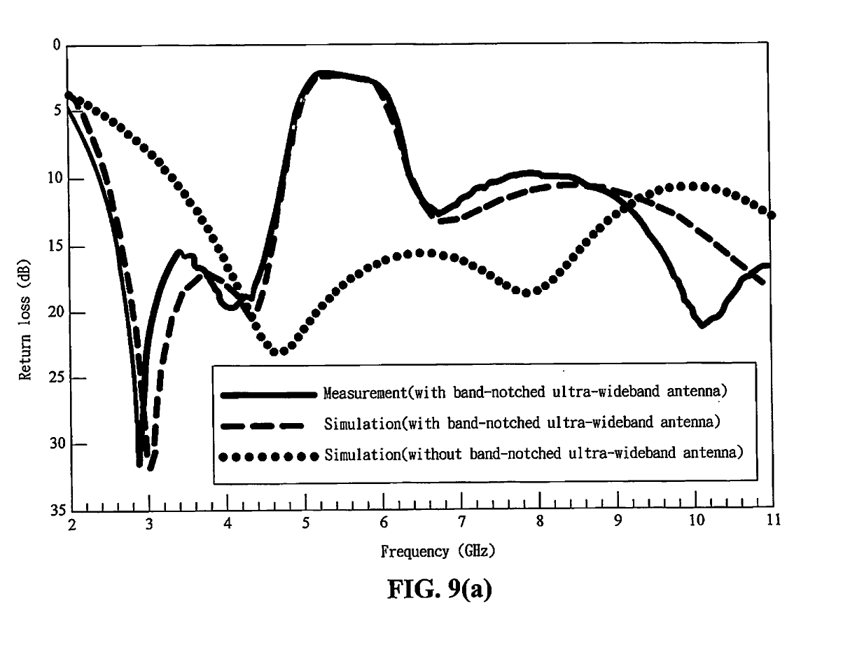

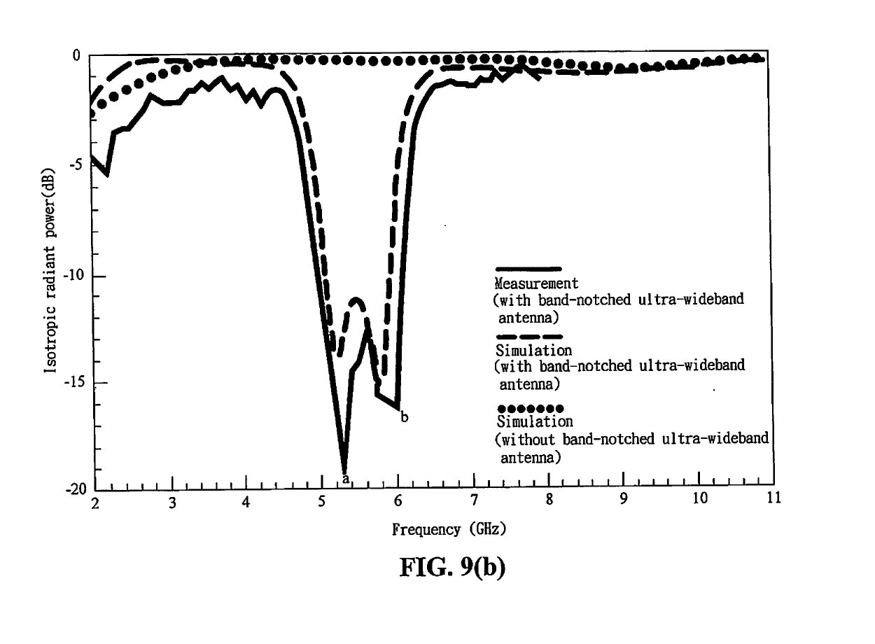

In turn, FIGS. 9 (a) and 9 (b) are the comparison figures of return loss, and isotropic radiant power frequency response between the band-notched ultra-wideband antenna 5 of the present invention and the conventional ultra-wideband antenna, in which simulation and measurement results of full-wave electromagnetic simulation software (Ansoft HFSS 10) used by the present invention and the simulation result without the band-notched ultra-wideband antenna are included in the charts. It is apparent from the figures that the band-notched ultra-wideband antenna 5 of the present invention, when compared with the conventional ultra-wideband antenna, has lower bandwidth in low frequency and this is due to the transmission zero generated at low frequency by the coupled open/short circuit stub 532 of the band-notched ultra-wideband antenna 5 of the present invention. If the second-order bandstop filter is embedded in basic antenna, it is apparent that the signals can be blocked between 5 GHz to 6 GHz successfully.

In the simulation result of the band-notched ultra-wideband antenna 5 of the present invention, two radiation nulls are generated at 5.25 GHz and 5.8 GHz. Further, the efficiency of the simulation result operated at frequency 5.5 GHz is 7.5%, while the efficiency of the simulation radiation at the two radiation nulls are all lower than 5%. When the measurement result and the simulation result are compared, they are similar to each other. Under the condition of the same circuit area, the band-notched ultra-wideband antenna 5 of the present invention has smooth return loss and full-wave radiation power response lower than −10 db at the stop band, and has higher band-stop-edge selectivity.

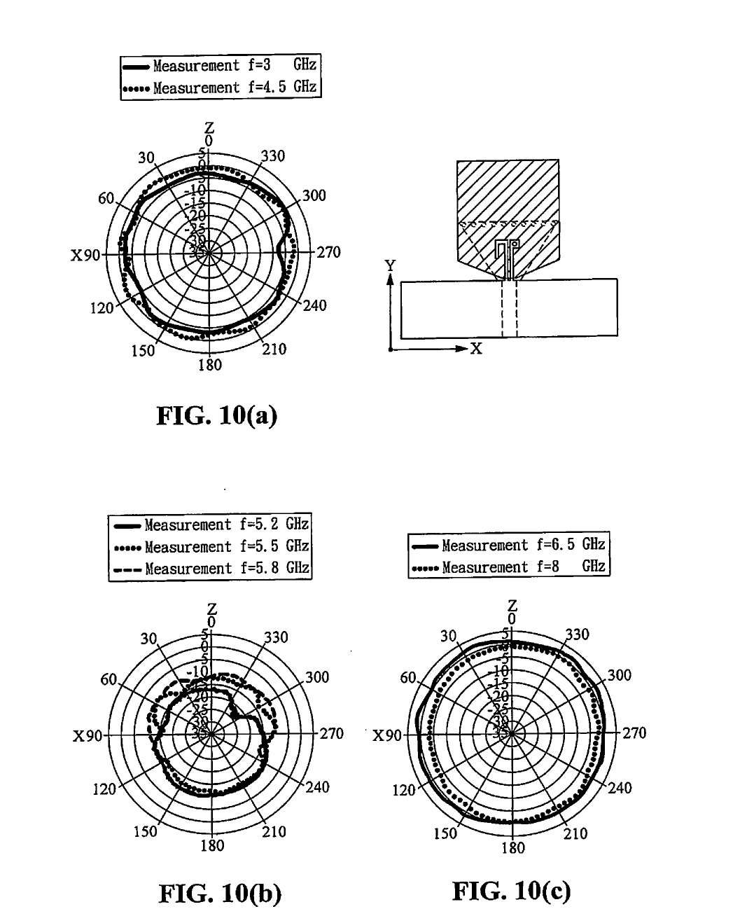

Next, FIGS. 10 (a), 10 (b) and 10 (c) are the measurement results of the antenna radiation pattern of the band-notched ultra-wideband antenna 5 respectively at low band, stopband, high band. As shown in the figures, the antenna radiation pattern on the x-y plane of the band-notched ultra-wideband antenna 5 of the present invention is omni-directional, the antenna gain thereof is about 0 dBi at low band and high band, and is at least less than −10 dBi at stopband.

According to the band-notched ultra-wideband antenna 5 in the present invention, resonant circuit with effective stopband can be designed under limited circuit area, not only wide band and high frequency edge selectivity can be provided but also the purpose of circuit miniaturization can be achieved. However, the above-mentioned embodiment is only for illustrative purpose, not intended to limit the scope of the present invention. Variations and modifications equivalent to the above embodiment and able to be realized are considered to be within the scope of the present invention.

What is claimed is:

1. A band-notched ultra-wideband antenna, comprising:
a top layer non-uniform short-circuit metal patch connected to a signal transmission section;
a middle layer metal radiation patch electrically connected to said top layer non-uniform short-circuit metal patch; and
a bottom layer metal patch having a ground metal pad and a coupled open/short circuit stub, said coupled open/short circuit stub comprising an open circuit stub and a short circuit stub electrically connected to said middle layer metal radiation patch;
wherein an equivalent circuit of said top layer non-uniform short-circuit metal patch is a parallel LC resonator, and an equivalent circuit of said coupled open/short circuit stub is a series LC resonator, a resonant frequency of said top layer non-uniform short-circuit metal patch being equivalent to a resonant frequency of said coupled open/short circuit stub, so that said top layer non-uniform short-circuit metal patch forms a second-order bandstop filter with said coupled open/short circuit stub.

2. The band-notched ultra-wideband antenna as claimed in claim 1, wherein said middle layer metal radiation patch functions as a ground plane for said coupled open/short circuit stub.

3. The band-notched ultra-wideband antenna as claimed in claim 1, wherein said middle layer metal radiation patch is a monopole ultra-wideband antenna, or some other ultra-wideband antennas and the variations thereof.

4. The band-notched ultra-wideband antenna as claimed in claim 1, wherein said open circuit stub is disposed substantially parallel to said short circuit stub along the same direction.

5. The band-notched ultra-wideband antenna as claimed in claim 1, wherein said open circuit stub and said short circuit stub are microstrip lines having the same length.

6. The band-notched ultra-wideband antenna as claimed in claim 1, wherein said open circuit stub and said short circuit stub are microstrip lines different in length.

7. The band-notched ultra-wideband antenna as claimed in claim 1, wherein said open circuit stub has a length which is a quarter of a wavelength corresponding to the resonant frequency of said coupled open/short circuit stub.

8. The band-notched ultra-wideband antenna as claimed in claim 1, wherein said coupled open/short circuit stub is disposed on the same plane in a microstrip line form, and wherein energy of said open circuit stub is coupled with energy of said short circuit stub through a notch.

9. The band-notched ultra-wideband antenna as claimed in claim 1, wherein said top layer non-uniform short-circuit metal patch has a length which is a quarter of a wavelength corresponding to the resonant frequency of said top layer non-uniform short-circuit metal patch.

10. The band-notched ultra-wideband antenna as claimed in claim 1, wherein said second-order bandstop filter is configured to combine with said ultra-wideband antenna so as to form two radiation nulls at the notch-band, so that two transmission zeros are produced at notch-band edges to obtain better notch-band edge selectivity.
